(19) United States
(12) Patent Application Publication
(10) Pub. No.: US 2014/0298934 A1
(43) Pub. Date: Oct. 9, 2014

(54) ANTI-ROTATION DEVICE FOR LINEAR ACTUATOR AND LINEAR ACTUATOR COMPRISING SAME

(71) Applicant: Thomson Industries Inc., Wood Dale, IL (US)

(72) Inventors: James MAREK, Huntington, NY (US); Rikard HENRYSSON, Kristianstad (SE)

(73) Assignee: Thomson Industries Inc., Wood Dale, IL (US)

(21) Appl. No.: 14/242,007

(22) Filed: Apr. 1, 2014

Related U.S. Application Data
(60) Provisional application No. 61/807,754, filed on Apr. 3, 2013.

(51) Int. Cl. F16H 25/24

(52) U.S. Cl. CPC F16H 25/24; F16H 2025/204
USPC 74/89.33

(57) ABSTRACT

An anti-rotation device for use in a linear actuator comprises a hollow body permitting passage of a screw therein. At least one pair of legs extends longitudinally away from the hollow body and each leg of the at least one pair includes a first key feature configured for mating or complementary engagement with a second key feature of an housing used to enclose the screw, nut and anti-rotation device. In one embodiment, each leg is configured to extend or flex radially outward relative to an outer diameter of the hollow body. In another embodiment, the second key features of the housing are substantially longitudinally uniform, whereas the first key feature of at least one of the legs includes a longitudinally non-uniform feature. These pre-loading features induce self-centering of the anti-rotation device that reduces or eliminates play between the components and noise while also improving performance of the linear actuator.

### CROSS-REFERENCE TO RELATED APPLICATION

The instant application claims the benefit of Provisional U.S. Patent Application Ser. No. 61/807,754 entitled “Radially and Laterally Preloaded Screw Carrier” and filed Apr. 3, 2013, the teachings of which are incorporated herein by this reference.

### FIELD

The instant disclosure relates generally to linear actuator comprising screws and captive nuts and, in particular, to anti-rotation devices for use therein.

### BACKGROUND

Linear actuators employing screws, such as lead screws or ball screws, and captive nuts are well known in the art. In use, a prime mover (typically a motor) is connected to the ball or lead screw by means of a coupling. A corresponding ball or lead nut is mounted onto the screw but is prevented from rotating by virtue of an anti-rotation feature of the nut itself or an anti-rotation device operatively connected to the nut. Typically, the anti-rotation feature or device engages a corresponding mating or complementary feature of the actuator housing, which is itself typically formed as an extrusion or a tubular structure. Because the nut is captive and prevented from rotating, rotation of the screw causes linear motion of the nut along a longitudinal axis of the screw and, consequently, the linear actuator. Often, a tubular structure or other element is operatively connected to the nut such that linear motion of the nut causes the tubular structure to extend out of or retract into the actuator housing.

An example of the construction of a typical prior art, screw-based linear actuator is further illustrated in FIG. 1. In particular, FIG. 1 illustrates a cross-sectional view in which a housing 100, having a hollow interior 101, encloses a screw 102 and nut 104. Note that the housing 100 may be formed as an extrusion as known in the art. A carrier 106 is provided as an anti-rotation device that engages the nut 104 in a fixed relationship. Because the carrier 106 necessarily moves along with the nut 104, a carrier bearing system 108, which may comprise a low-friction polymer material attached to the carrier 106 thereby translating along the length of the housing, is also provided in order to ensure smooth translation of the carrier within the housing 100. Engagement of the carrier 106 with corresponding features in the housing 100 (in this case, via the carrier bearing system 108), along with the captive relationship between the nut 104 and the carrier 106, prevents rotation of the nut 104 during rotation of the screw 102.

Given variances in manufacturing tolerances between the various illustrated components, particularly the housing 100, the carrier 106 and the bearing system 108, it is often necessary to provide shims to ensure a minimum clearance condition, thereby reducing any potential “play” or “slop” between the components. As known in the art, such play decreases accuracy of movements of the constituent parts, which, in turn, can lead to unsatisfactory performance of the linear actuator. However, considerable time and expense is often incurred in the necessary shimming operations. Furthermore, normal wear may require re-shimming, incurring further downtime and expense.

### SUMMARY

The instant disclosure describes an anti-rotation device or carrier that addresses the shortcomings noted above. In an embodiment, the anti-rotation device comprises a hollow body that permits passage of the screw therein. A surface of the hollow body is provided for engaging or otherwise operatively connecting the hollow body to a nut. In an embodiment, the nut is operatively connected to the hollow body by an intervening middle carrier configured to interface with conventional ball or lead nuts. At least one pair of legs extends longitudinally away from the hollow body in a first direction (e.g., toward the nut). Each leg of the at least one pair includes a first key feature that is configured for mating or complementary engagement with a second key feature of a housing used to enclose the screw, nut, middle carrier and anti-rotation device. In one embodiment, each leg of the at least one pair of legs is configured to extend or flex radially outward relative to an outer diameter of the hollow body. In another embodiment, the second key features of the housing are substantially longitudinally uniform, i.e., each having essentially constant dimensions within normal manufacturing tolerances along the entire length of the housing. In this embodiment, the first key feature of at least one of the legs includes a longitudinally non-uniform feature that causes an interference fit between the first and second features. For example, the longitudinally non-uniform feature may be an at least partial split formed in the first key feature and a longitudinal curvature included in the first key feature.

The first key feature may comprise a protruding tab, relative to the outer diameter of the hollow body, radially extending away from the outer diameter of the hollow body and (with the exception of any longitudinally non-uniform features) substantially matching, while providing a clearance fit with, the second key features. Additionally, the first key features may further extend along a length of each leg and the hollow body. Further still, each leg of each pair of legs may be located opposite each other along a circumference of the hollow body and, where multiple pairs of legs are used, all of the legs may be equidistant from each other along the circumference of the hollow body. Whereas the first key feature of a first pair of legs may extend so as to substantially match the corresponding second key feature, the first key feature of a second pair of legs may be modified to extend a lesser height such that a space is provided between the first modified key features and the corresponding second key features.

Linear actuators incorporating anti-rotation devices in accordance with the various disclosed embodiments are also described herein.

Further still, a nut incorporating the various features described herein may also be provided and incorporated into a linear actuator.

### BRIEF DESCRIPTION OF THE DRAWINGS

The features described in this disclosure are set forth with particularity in the appended claims. These features will become apparent from consideration of the following detailed description, taken in conjunction with the accompanying drawings. One or more embodiments are now described, by way of example only, with reference to the accompanying drawings wherein like reference numerals represent like elements and in which:

FIG. 1 is a cross-sectional view of a linear actuator in accordance with the prior art techniques;

FIG. 2 is a partial, exploded view of a linear actuator in accordance with an embodiment of the instant disclosure;

FIG. 3 is an isometric view of an anti-rotation device or carrier in accordance with an embodiment of the instant disclosure;

FIG. 4 is a top view of the anti-rotation device or carrier of FIG. 3;

FIG. 5 is a cross-sectional view of a housing and the anti-rotation device or carrier of FIG. 3;

FIG. 6 is a cross-sectional view illustrating engagement of the anti-rotational device or carrier of FIG. 3 with various other components of a linear actuator; and

FIG. 7 is a cross-sectional, perspective view of a nut in accordance with another embodiment of the instant disclosure.

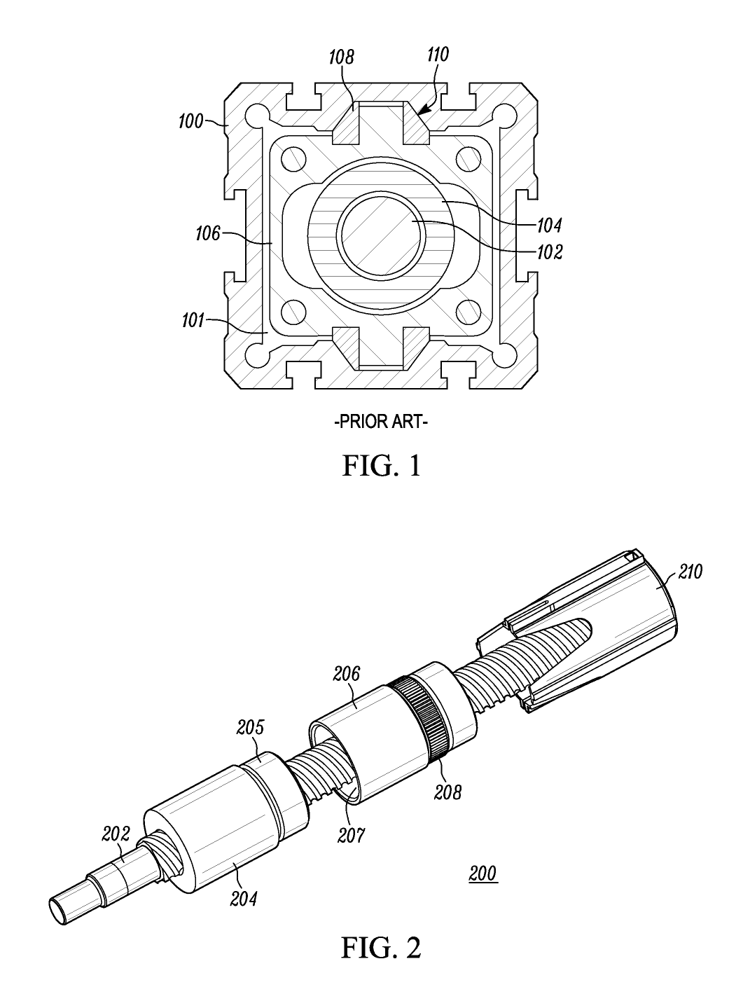

### DETAILED DESCRIPTION OF THE PRESENT EMBODIMENTS

Referring now to FIG. 2, an embodiment of a linear actuator 200 in accordance with the instant disclosure is partially illustrated. As shown, the linear actuator 200 comprises a screw 202, nut 204, a middle carrier 206 and anti-rotation device 210. As will be appreciated by those having ordinary skill in the art, a number of other elements typically found in a screw-based linear actuator, e.g., screw bearings, extension tube, housing, etc., are not shown in FIG. 2 for ease of illustration.

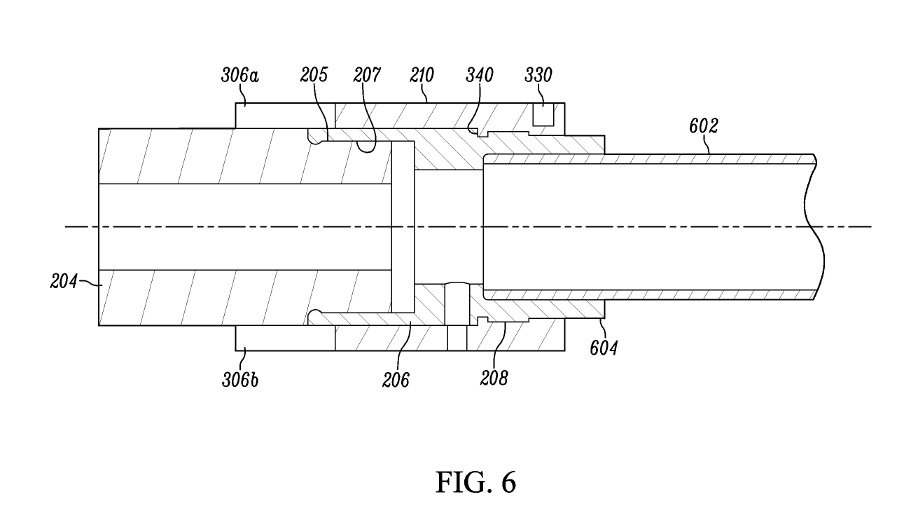

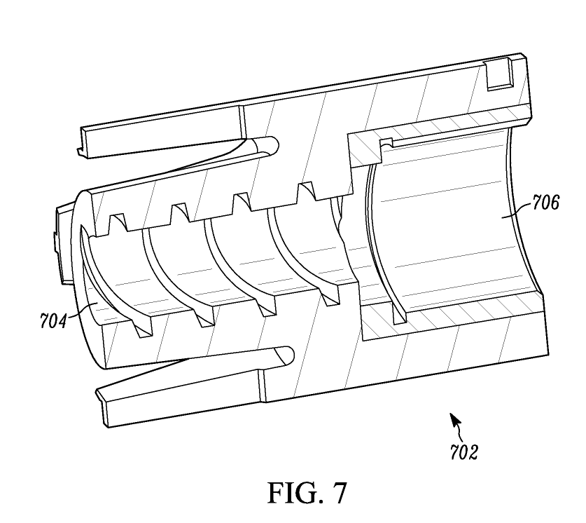

As known in the art, the screw 202 may comprise a lead screw or ball screw of various lengths and configurations, and manufactured from materials commonly used in the art. The nut 204 may comprise a corresponding lead nut or ball nut as also known in the art and, as before, may assume any of a number of configurations and be manufactured from materials well known in the art. More generally, the instant disclosure is not limited by the particular construction or configuration of the screw 202 and nut 204. In the illustrated embodiment the nut includes a male threaded surface 205 for mating or complementary engagement with a female threaded surface 207 of a middle carrier 206, which is preferably manufactured of aluminum. As shown, the middle carrier 206 comprises an internal opening permitting passage of the screw 202 therein. The middle carrier 206 is a transition piece that facilitates a connection between the nut 204 and extension tube 602, as described below relative to FIG. 6. This is particularly advantageous as it permits the use of standard, commercially available nuts 204. Also, as known in the art, it is preferable for the extension tube 602 (which extends out the linear actuator to engage the desired external load) to have a diameter less than the diameter of the nut 204 at that point where the nut 204 engages the anti-rotation device 206, e.g., the diameter where the male threaded surface 205 engages the female threaded surface 207. In this vein, the middle carrier 206 may be provided with a correspondingly lesser-diameter feature to permit engagement with the extension tube 602. Furthermore, as described below, the anti-rotation device 210 is preferably formed of a suitable polymer material, whereas the extension tube 602 is typically manufactured of a suitable metal material. Thus, the middle carrier 205 provides an appropriate interface for engagement with the extension tube 602. That said, the middle carrier 206 is not a requirement and it is possible to construct the anti-rotation device 210 and/or the nut 204 to incorporate some or all of the above-noted features of the middle carrier 206, thereby eliminating the need for the middle carrier 206.

Regardless, when provided, the middle carrier 206 comprises knurling 208 to provide an interference fit with an anti-rotation device 210. In an embodiment, the knurling 208 is designed to substantially eliminate rotation of the middle carrier 206 (and, consequently, the nut 204) relative to the anti-rotation device 210, e.g., a linear knurl extending longitudinally along a portion of an exterior surface of the middle carrier 206.

As best illustrated in FIG. 6, the anti-rotation device 210, when coupled to the middle carrier 206, substantially envelopes the middle carrier 206 such that the nut 204, middle carrier 206 and anti-rotation device 210 form a relatively rigid assembly. Alternatively, where the anti-rotation device 210 and nut 204 are configured for direct attachment to each other, i.e., without the intervening middle carrier 206, the anti-rotation device 210 may be configured to substantially envelope only the nut 204. In an embodiment, the anti-rotation device 210 is fabricated as a molded, polymer material such as Delrin® or other known, engineered plastic material having suitable lubricity and pressure-velocity (PV) values. As described in greater detail below, the anti-rotation device 210 may comprise various features directed to reducing or eliminating play between the various components illustrated in FIG. 2 and the housing (not pictured).

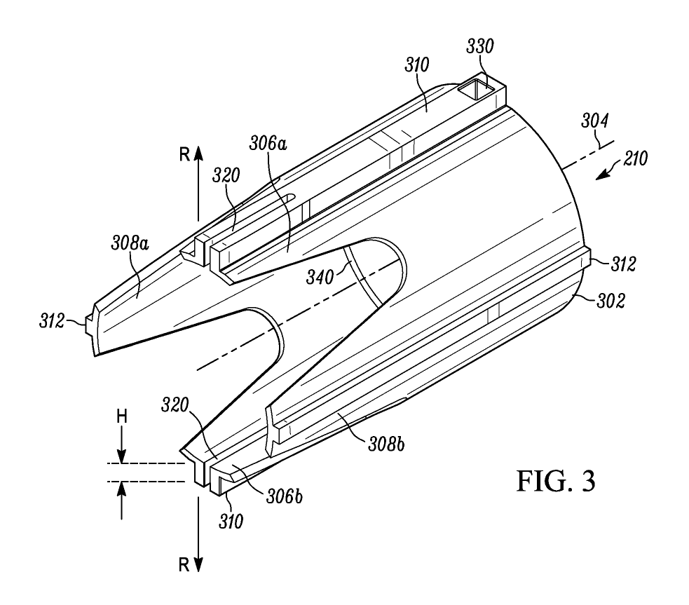

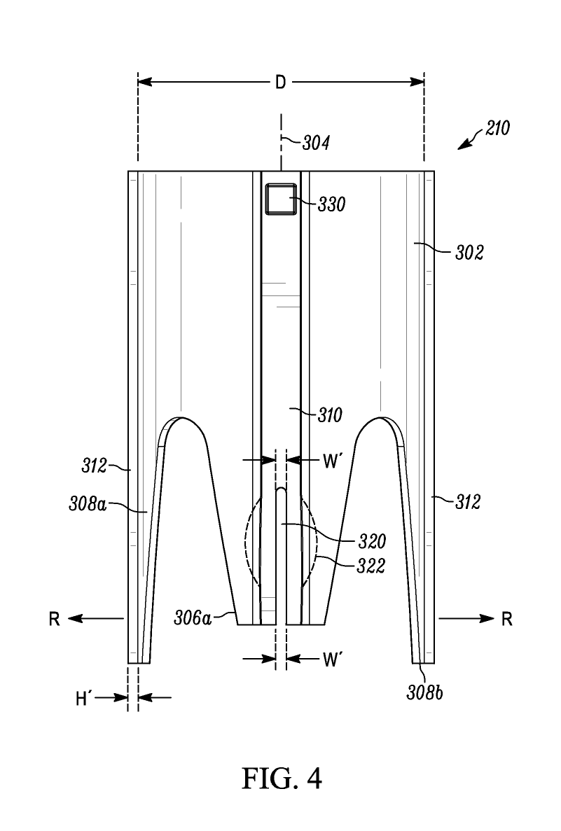

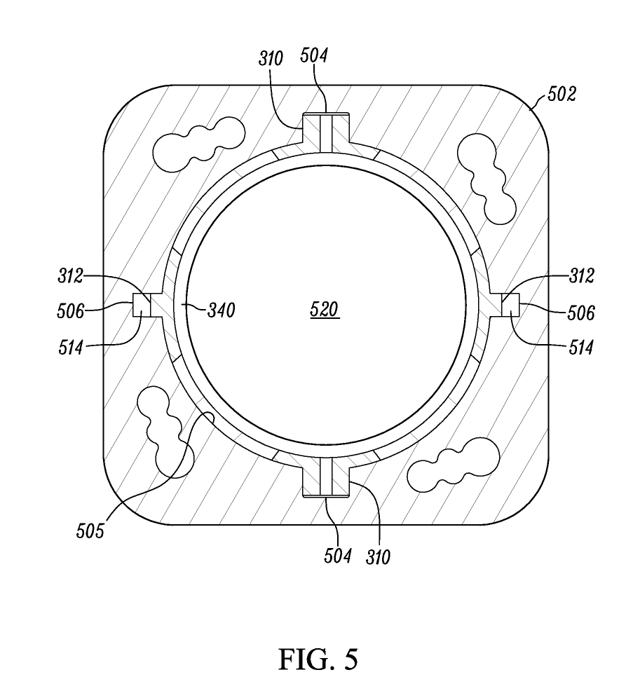

Referring now to FIGS. 3 and 4, the anti-rotation device 210 is illustrated in greater detail. In the illustrated embodiment, the anti-rotation device 210 comprises a hollow body 302 having a substantially cylindrical shape. The hollow body 302 defines an opening 520 (FIG. 5) large enough to accommodate the screw 202, nut 204 and middle carrier 206 as illustrated in FIG. 6. Although the hollow body 302 is illustrated having a cylindrical shape, it is noted that this is not a requirement of the instant disclosure and the hollow body 302 may comprise virtually any desired outer shape capable of cooperating with a housing (not shown) and capable of receiving the noted components within its opening 520. Additionally, it is preferable that the hollow body be concentric and generally symmetric about a longitudinal axis 304 of the screw 202.

As known in the art, linear actuators are typically sensitive to side or radial loads, i.e., forces that are substantially perpendicular to the longitudinal axis 304, applied to the nut 204 as such forces have a tendency to tilt the axis of the nut 204 relative to the screw 202, causing uneven loading of the threads or balls. In turn, this reduces life and can create objectionable noise. It can also increase frictional forces between the screw 202 and nut 204, thereby reducing the efficiency of the nut/screw assembly. In an embodiment, the hollow body 302 preferably has a surface area sufficient to substantially envelope the nut 204 and middle carrier 206, thereby providing a broad surface and enabling comparatively wide distribution of any side loads placed thereon. Such broader distribution of radial forces minimizes the impact (i.e., rotation or tilting) on the interface between the screw 202 and nut 204. Furthermore, as described in greater detail below, stability is further enhanced by the radially preloaded legs.

As further shown, the anti-rotation device 210 comprises at least one pair of legs 306, 308 extending away from the hollow body 302 along the longitudinal axis 304 in a first direction. Although a single pair of legs may be used in accordance with the instant disclosure, in the illustrated embodiment, two pairs of legs comprising a first pair of legs 306 and a second pair of legs 308 are shown. However, it is understood that the further pairs of legs beyond two could be equally employed. In an embodiment, the legs 306a, 306b, 308a, 308b of each pair are arranged opposite each other along a circumference of the hollow body 302. Thus, in the illustrated example comprising a cylindrical hollow body, each leg 306a, 308a is arranged substantially 180 degrees away from its corresponding leg 306b, 308b in the pair. Furthermore, all of the legs 306a, 306b, 308a, 308b are preferably equidistant from each other along the circumference of the hollow body. Thus, in the illustrated example, each leg 306a, 306b, 308a, 308b is positioned 90 degrees away from the adjacent legs along the circumference of the hollow body 302. Additionally, in the illustrated embodiment, the first pair of legs 306 are shorter in length than the second pair of legs 308, as best shown in FIG. 4, though, once again, this is not requirement as the pairs of legs 306, 308 may be of equal length. Generally, the length of the legs 306a, 306b, 308a, 308b may be chosen as a matter of design choice to balance the beneficial stability effect realized by a longer bearing surface of the hollow body 302 versus stroke length that is lost by virtue of the length of the anti-rotation device 210.

In an embodiment of the instant disclosure, at least one, but preferably each, of the legs extends or flexes radially outward relative to an outer diameter, D, of the hollow body 302. This radial extension or flexure is illustrated in FIGS. 3 and 4 by the radially directed (relative to the longitudinal axis 304) arrows, R. In practice, such radial extension or flexure may be the natural result of molding the legs 306a, 306b, 308a, 308b from a polymer material in a cantilevered fashion, as illustrated. That is, upon removal of the anti-rotation device 210 from a mold, the cantilevered legs, even if formed in the mold in substantial longitudinal alignment with the outer dimension of the hollow body 302, exhibits a natural tendency to flex in the outward radial direction, as shown. Alternatively, such radial extension may be expressly designed into the legs 306a, 306b, 308a, 308b. The degree of extension exhibited by the legs 306a, 306b, 308a, 308b is preferably selected to balance between providing too much pre-load (spring force) against the housing 502 (see FIG. 5) thereby leading to excess friction, versus too little pre-load leading to ineffective control of the undesirable play between the constituent elements. Those having ordinary skill in the art will appreciate that the design of these pre-load forces can be tailored to an application such that no more force is provided than that required to keep the nut 204 substantially on axis with the screw 202.

As further shown in FIGS. 3 and 4, each of the legs 306a, 306b, 308a, 308b comprises a corresponding first key feature 310, 312 that, as best illustrated in FIG. 5, are configured for mating or complementary engagement with second key features 504, 506 formed in a housing 502. In the illustrated embodiment, the first key features 310, 312 comprise protruding tabs radially extending (relative to the longitudinal axis 304) a height, H or H′, beyond the outer diameter, D, of the hollow body 302. Likewise, the second key features 504, 506 (see FIG. 5) in the illustrated embodiment, radially extend into the housing 502. Thus, as shown, the first key features 310 associated with the first pair of legs 306 generally engage in a clearance fit with their corresponding second key features 504. However, given the extension or flexure of the legs 306, 308, that portion of the hollow body 302 adjacent the first key features 310, 312 and forming the legs 306, 308 establishes an interference fit, as best illustrated in FIG. 5, with an inner diameter 505 of the housing 502. In this manner, any play between the hollow body 302 and the housing 502 is reduced, if not eliminated entirely.

In the illustrated embodiment, the second height, H′, of the first key features 312 associated with the second pair of legs 308 is less than the first height, H, of the first key features 310 associated with the first pair of legs 306. As illustrated in FIG. 5, this results in the establishment of a space 514 between the first key features 312 and their corresponding second key features 506. In an embodiment, these spaces 514 permit the displacement of air (or any other fluid) from one end of the housing to another as the assembly comprising the anti-rotation device 210 and nut 204 linearly traverses the length of the screw 202. It is noted that, although the second height, H′, is illustrated as being less than the first height, H, this is not a requirement as the relative magnitudes of the first and second heights may be reversed as a matter of design choice. Furthermore, both the first and second height could be set at values less than the full height of the recess forming the second key features 504, 506 such that spaces are created relative to the first key features of all of the legs 306a, 306b, 308a, 308b. Further still, it is possible that the first and/or second heights could be set at values that provide an interference fit between corresponding ones of the first key features 310, 312 and the second key features 504, 506.

Additionally, although the first and second key features have been illustrated as comprising male and female mating structures, respectively, this is not a requirement. That is, the first key features 310, 312 can be formed as recesses formed in the legs 306a, 306b, 308a, 308b and hollow body 302, whereas the second key features 504, 506 in the housing 502 can be formed as protruding tabs. Further still, though the first and second key features are illustrated as comprising substantially matching rectangular profiles, this is, once again, not a requirement as virtually any suitable geometry may be used for this purpose, provided that the mating engagement of the first and second key features is sufficiently secure to prevent any rotation of the hollow body 302 and, consequently, of the operatively connected nut 204.

As described above, the anti-rotation device 210 can incorporate radial pre-loads to reduce or altogether eliminate any centric play of the anti-rotation device 210 and the operatively connected nut 204. In an alternate embodiment, rotational or lateral play between the anti-rotation device 210 and the housing 502 may be reduced or eliminated through the provision of further pre-loaded features on the anti-rotation device 210. In an embodiment, this is achieved through the use of longitudinally non-uniform features in the anti-rotation device 210.

As used herein, a longitudinally non-uniform feature is a feature whose dimensions vary at different points along that feature's longitudinal length, particularly with respect to a corresponding longitudinally uniform feature with which the non-uniform feature engages in a mating or complementary relationship. In an embodiment, such longitudinally non-uniform features may be incorporated into one or more of the first key features 310, 312. Specific examples of such longitudinally non-uniform features are illustrated in FIG. 4.

As a first example, an at least partial split 320 may be provided in one or more of the legs 306a, 306b, 308a, 308b, particularly through the first key feature 310. In the illustrated embodiment, the split 320 is provided in only the legs of the first pair 306. Once again, however, it is understood that the split 320 may be provided in any number of the legs 306a, 306b, 308a, 308b as a matter of design choice. In an embodiment, and with further reference to FIG. 4, the split 320 may begin at any desirable point along the leg 306a. In the illustrated embodiment, the split 320 begins at a point after the leg 306a extends away from hollow body 302. Generally, the width of the split 320, W, is uniform along the length of the split 320, i.e., from the end of the split 320 closest to the hollow body 302 to a distal end of the leg 306. Additionally, though the split 320 in the illustrated embodiment extends from a point along each leg 306 all the way through the distal end of each leg 306, this is not required. For example, the split could terminate at some point prior to the distal end of the leg 306, effectively forming a slot in the leg 306.

Regardless, the leg 306 exhibits a longitudinally non-uniform feature in the form of a positive bulge or boss 322, schematically exaggerated in FIG. 4 for ease of illustration, intentionally designed into the first key feature 310. Thus, when the first key feature 310 is engaged with the corresponding second key feature 504, the bulge 322 establishes an interference fit with the second key feature 504. The resulting pre-load or spring force thus provided by the first key feature 310 may be controlled by dimensions of the bulge 322 and the split 320. That is, as shown, the interference fit between the bulge 322 and the second key feature 504 causes the width, W′, of the split 320 at the distal end of the leg 306a to be less than the original width, W, of the split 320. By selecting dimensions and geometry (e.g., complete or partial slit, width, etc.) of the bulge 322 and the split 320, the resulting spring force may be controlled to a desired level. An advantage of the lateral pre-load thus provided is that the “clicking” noise often experienced in a conventional linear actuator—resulting from play between components in the rotational direction—may be substantially reduced or eliminated, which can be an important consideration for linear actuators in medical and other noise sensitive applications.

Regardless of their implementation, it is noted that the longitudinally non-uniform features 322 are preferably laterally symmetric, i.e., a variance in one lateral direction is balanced by a similar variance in the other lateral direction at the same longitudinal point along the first key feature 310, thereby minimizing any tendency to induce rotation of the anti-rotation device 210 about an axis perpendicular to the longitudinal axis 304. Furthermore, it is preferred to longitudinally arrange the non-uniform features substantially close to that point where the nut 204 threadably engages the screw 202.

When present, the longitudinally non-uniform features of the first key feature 310 provide an interference fit with the corresponding second key features 504, thereby providing a pre-load force that permits the anti-rotation device 210 to minimize or eliminate any rotational or lateral play between the anti-rotation device 210 (and, consequently, the captive nut 204) and the housing 502.

Once again referring to FIGS. 3 and 4, the hollow body 302 may comprise a recess 330 formed therein, for example, within the thickness of one or more of the first key features 310. In this embodiment, a magnet may be placed in the recess 330. Operating in conjunction with one or more proximity switches placed along the length of a linear actuator, the magnets may provide home, trigger and/or end limit event indications. As known in the art, such event indications may be used to control operation of a linear actuator.

Additionally, with further reference to FIGS. 3, 5 and 6, the hollow body 302 may comprise a shoulder 340 formed on an inner surface thereof. The shoulder 340, which effectively defines an interior region of lesser diameter relative to an adjacent interior region, may operate to serve as a stop for the middle carrier 206 when inserted into the anti-rotation device 210. With additional reference to FIG. 6, the engagement of the nut 204, middle carrier 206 and anti-rotation device 210 are further illustrated. Engaged in this manner, it is noted that the above described pre-loaded elements, i.e., either the radially extending legs and/or the longitudinally non-uniform features, are essentially centered at or near the interface between the nut 204 and the screw 202 (not shown in FIG. 6). Because these pre-load forces tend to center the anti-rotation device 210 within the housing 502, the nut 204 is also biased into a balanced position relative to the screw 202. FIG. 6 also illustrates the engagement of an extension tube 602, as known in the art, with the middle carrier 206. Additionally, although not shown in FIG. 6, a lock nut or the like may be attached to the portion 604 of the middle carrier 206 extending beyond the interior region of the anti-rotation device 210 such that, in conjunction with the abutment of the shoulder 340 with a corresponding shoulder of the middle carrier 206, the anti-rotation device 210 is firmly maintained in longitudinal alignment with the middle carrier 206.

While the embodiments shown in FIGS. 3-6 illustrate a preferred configuration in which both the radially extending legs and the longitudinally non-uniform features on present on a single device 210, this is not a requirement as these feature may be provided independently of the other.

Finally, with regard to FIG. 7, a nut 702 is illustrated in which the above-described pre-load features, i.e., radially extending legs and/or longitudinally non-uniform features (both, in the illustrated example) are integrated into the nut itself, which is preferably formed of a suitable polymer as described above. In this embodiment, the middle carrier 206 is essentially incorporated into the nut 702 and a threaded interior surface 704, configured for mating engagement with threads of the screw 202, is provided. As further shown, the nut 702 may comprise an insert 706 around which the nut 702 (including the feature of the anti-rotation device) is overmolded. The insert 706 comprises internal threads (not shown) configured to mate with the extension tube 602. Although the embodiment illustrated in FIG. 7 is particularly applicable to a lead screw, a similar configuration incorporating the elements of a ball nut for use with a ball screw may also be provided. The embodiment of FIG. 7 may provide a particularly cost effective solution as compared to other embodiments described herein.

While particular preferred embodiments have been shown and described, those skilled in the art will appreciate that changes and modifications may be made without departing from the instant teachings. It is therefore contemplated that any and all modifications, variations or equivalents of the above-described teachings fall within the scope of the basic underlying principles disclosed above and claimed herein.

What is claimed is:

1. An anti-rotation device for use in a linear actuator of the type comprising a screw and a nut enclosed in a housing in which the nut is prevented from rotating by the anti-rotation device in communication with the housing, and in which rotation of the screw causes the nut to move along a longitudinal axis of the screw, the anti-rotation device further comprising:
a hollow body permitting passage of the screw therein and comprising a surface configured to operatively connect the hollow body to the nut; and
at least one pair of legs extending longitudinally away from the hollow body in a first direction and each leg of the at least one pair of legs comprising a first key feature configured to engage corresponding second key features of the housing,
wherein each leg of the at least one pair of legs extends radially outward relative to an outer diameter of the hollow body.

2. The anti-rotation device of claim 1, wherein the first key feature is a protruding tab extending radially away from the outer diameter of the hollow body, and wherein the second key features are recesses in the housing configured to accept the protruding tabs and extending along a length of the housing.

3. The anti-rotation device of claim 2, wherein the first key feature extends along a length of each leg of the at least one pair of legs and the hollow body.

4. The anti-rotation device of claim 1, wherein the legs of the at least one pair of legs are opposite each other along a circumference of the hollow body.

5. The anti-rotation device of claim 4, wherein the at least one pair of legs comprises a first pair of legs and a second pair of legs, each pair of legs extending longitudinally away from the hollow body in the first direction, wherein the legs of each pair of legs are opposite each other along the circumference of the hollow body and all of the legs are spaced equidistant from each other along the circumference hollow body.

6. The anti-rotation device of claim 5, wherein the first key feature of each leg of the second pair of legs is modified to leave space between the modified first key feature and the corresponding second key feature during engagement with each other.

7. The anti-rotation device of claim 1, wherein the hollow body comprises a recess configured to hold a magnet.

8. The anti-rotation device of claim 1, wherein the second key features are longitudinally uniform and the first key feature of at least one of the legs includes a longitudinally non-uniform feature so as to cause an interference fit with the corresponding second key feature.

9. The anti-rotation device of claim 8, wherein the longitudinally non-uniform feature of at least one of the legs is an at least partial split formed in the first key feature and a longitudinal curvature included in the first key feature.

10. An anti-rotation device for use in a linear actuator of the type comprising a screw and a nut enclosed in an housing in which the nut is prevented from rotating by the anti-rotation device in communication with the housing, and in which rotation of the screw causes the nut to move along a longitudinal axis of the screw, the anti-rotation device further comprising:
a hollow body permitting passage of the screw therein and comprising a surface configured to operatively connect the hollow body to the nut; and
at least one pair of legs extending longitudinally away from the hollow body in a first direction and each leg of the at least one pair of legs comprising a first key feature configured to engage corresponding second key features of the housing,
wherein the second key features are longitudinally uniform and the first key feature of at least one of the legs includes a longitudinally non-uniform feature so as to cause an interference fit with the corresponding second key feature.

11. The anti-rotation device of claim 10, wherein the first key feature is a protruding tab extending radially away from the outer diameter of the hollow body, and wherein the second key features are recesses in the housing configured to accept the protruding tables and extending along a length of the housing.

12. The anti-rotation device of claim 11, wherein the first key feature extends along a length of each leg of the at least one pair of legs and the hollow body.

13. The anti-rotation device of claim 10, wherein the legs of the at least one pair of legs are opposite each other along a circumference of the hollow body.

14. The anti-rotation device of claim 13, wherein the at least one pair of legs comprises a first pair of legs and a second pair of legs, each pair of legs extending longitudinally away from the hollow body in the first direction, wherein the legs of each pair of legs are opposite each other along the circumference of the hollow body and all of the legs are spaced equidistant from each other along the circumference hollow body.

15. The anti-rotation device of claim 14, wherein the first key feature of each leg of the second pair of legs is modified to leave space between the modified first key feature and the corresponding second key feature during engagement with each other.

16. The anti-rotation device of claim 10, wherein the hollow body comprises a recess configured to hold a magnet.

17. The anti-rotation device of claim 10, wherein the longitudinally non-uniform feature of at least one of the legs is an at least partial split formed in the first key feature and a longitudinal curvature included in the first key feature.

18. A linear actuator comprising:
a housing;
a screw and a nut enclosed in the housing;
an anti-rotation device operatively connected to the nut and configured to prevent rotation of the nut such that rotation of the screw causes the nut to move along a longitudinal axis of the linear actuator, the anti-rotation device further comprising:
a hollow body permitting passage of the screw therein and comprising a surface configured to operatively connect the hollow body to the nut; and
at least one pair of legs extending longitudinally away from the hollow body in a first direction and each leg of the at least one pair of legs comprising a first key feature configured to engage corresponding second key features of the housing,
wherein each leg of the at least one pair of legs extends radially outward relative to an outer diameter of the hollow body.

19. A linear actuator comprising:
a housing;
a screw and a nut enclosed in the housing;
an anti-rotation device operatively connected to the nut and configured to prevent rotation of the nut such that rotation of the screw causes the nut to move along a longitudinal axis of the linear actuator, the anti-rotation device further comprising:
a hollow body permitting passage of the screw therein and comprising a surface configured to operatively connect the hollow body to the nut; and
at least one pair of legs extending longitudinally away from the hollow body in a first direction and each leg of the at least one pair of legs comprising a first key feature configured to engage corresponding second key features of the housing,
wherein the second key features are longitudinally uniform and the first key feature of at least one of the legs includes a longitudinally non-uniform feature so as to cause an interference fit with the corresponding second key feature.

20. A nut for use in a linear actuator of the type comprising a screw enclosed in an housing in which the nut is prevented from rotating such that rotation of the screw causes the nut to move along a longitudinal axis of the linear actuator, the nut further comprising:
a hollow body permitting passage of the screw therein and comprising a threaded interior surface configured to engage threading on the screw; and
at least one pair of legs extending longitudinally away from the hollow body in a first direction and each leg of the at least one pair of legs comprising a first key feature configured to engage corresponding second key features of the housing,
wherein each leg of the at least one pair of legs extends radially outward relative to an outer diameter of the hollow body.

21. A nut for use in a linear actuator of the type comprising a screw enclosed in an housing in which the nut is prevented from rotating such that rotation of the screw causes the nut to move along a longitudinal axis of the linear actuator, the nut further comprising:
a hollow body permitting passage of the screw therein and comprising a threaded interior surface configured to engage threading on the screw; and
at least one pair of legs extending longitudinally away from the hollow body in a first direction and each leg of the at least one pair of legs comprising a first key feature configured to engage corresponding second key features of the housing,
wherein the second key features are longitudinally uniform and the first key feature of at least one of the legs includes a longitudinally non-uniform feature so as to cause an interference fit with the corresponding second key feature.

22. A linear actuator comprising:
a housing;
a screw enclosed in the housing; and
a nut further comprising:
a hollow body permitting passage of the screw therein and comprising a threaded interior surface configured to engage threading on the screw; and
at least one pair of legs extending longitudinally away from the hollow body in a first direction and each leg of the at least one pair of legs comprising a first key feature configured to engage corresponding second key features of the housing,
wherein each leg of the at least one pair of legs extends radially outward relative to an outer diameter of the hollow body.

23. A linear actuator comprising:
a housing;
a screw enclosed in the housing; and
a nut further comprising:
a hollow body permitting passage of the screw therein and comprising a threaded interior surface configured to engage threading on the screw; and
at least one pair of legs extending longitudinally away from the hollow body in a first direction and each leg of the at least one pair of legs comprising a first key feature configured to engage corresponding second key features of the housing,
wherein the second key features are longitudinally uniform and the first key feature of at least one of the legs includes a longitudinally non-uniform feature so as to cause an interference fit with the corresponding second key feature.
